(19) United States
(12) Patent Application Publication
(10) Pub. No.: US 2008/0047350 A1
(43) Pub. Date: Feb. 28, 2008

(54) USE OF ULTRASOUND FOR MONITORING SECURITY OF SHIPPING CONTAINERS

(75) Inventors: Les Atlas, Seattle, WA (US); Jonathan Cutter, Marlborough, MA (US); Patrick McVittie, Seattle, WA (US)

Correspondence Address: LAW OFFICES OF RONALD M ANDERSON, 600 108TH AVE, NE, SUITE 507, BELLEVUE, WA, 98004, US

(73) Assignee: University of Washington, Seattle, WA (US)

(21) Appl. No.: 11/841,198

(22) Filed: Aug. 20, 2007

Related U.S. Application Data
(60) Provisional application No. 60/823,349, filed on Aug. 23, 2006.

(51) Int. Cl. G01N 29/04

(52) U.S. Cl. 73/625

(57) ABSTRACT

Ultrasound is used to detect either or both the opening of a door of a shipping container or a change in the contents of a shipping container. Ultrasound signals transmitted from one or more ultrasonic transducers configured to be mounted within an interior of a shipping container travel through the interior and are reflected by a reflector, e.g., a corner reflector. The reflected ultrasound is received by an ultrasonic receiver, which produces an output signal corresponding to the received ultrasound signal. If the ultrasonic transducer or the reflector is mounted on the door, the time of flight of the ultrasound signal can be used to determine the distance that the ultrasound signal travels. Opening the door changes this distance, which can be detected. Similarly, changes in ultrasound reflected from contents in the shipping container can be detected and used to detect changes in the contents, which may be caused by terrorist activity.

### RELATED APPLICATIONS

This application is based on a prior copending provisional application, Ser. No. 60/823,349, filed on Aug. 23, 2006, the benefit of the filing date of which is hereby claimed under 35 U.S.C. §119(e).

### BACKGROUND

Since the 1950s, large ships have been transporting shipping containers by sea. By using containers that are typically up to forty feet in length, these ships can dock at specially equipped ports that use overhead cranes to transfer the containers from the ships to docks and then to trains or trucks, saving a tremendous amount of loading and unloading time.

Container ships can transfer up to 20 tons of goods, since the largest container ships currently can hold up to 4,000 forty-foot containers. About 90 percent of international trade is handled by these ships, and about one-hundred million containers are shipped between countries on such vessels.

About 27,000 containers enter U.S. ports on ships each day, which makes security a very difficult problem. In addition to the number of containers that need to be checked, there is also a need to stay on schedule so as to not delay the shipment of incoming goods. Efficiently moving shipping containers to their destinations enables businesses to function at lower cost and thus is very important to this country's economy.

However, since Sep. 11, 2001, it has become evident that allowing containers to be brought into this country aboard ships that dock in ports that are in major metropolitan areas along this country's coasts represents an unacceptable risk if steps are not taken to detect whether nuclear, chemical, or biological agents have been placed in the container to be dispersed either in the port where the container enters this country or in some other city to which the container has been carried by truck or train. Clearly, this country must take steps to detect possible terrorist threats that might be carried out using the containers shipped into the U.S. from abroad. Terrorist attacks have become a much more significant concern in this country, and it is extremely important to take steps to better protect this country from terrorist attacks that use containers that are brought into this country on ships.

Devices such as gamma ray detectors may be used to detect a nuclear device in a container, and other forms of detector devices are being developed to identify other types of terrorist contents in a container. However, such detector devices are relatively expensive and not practical to use in checking each container entering a port on ships. In many cases, it may be sufficient to simply detect whether any container on a ship has been opened at some point, which may have occurred when a terrorist group was replacing the original contents with a bomb or other terrorist threat. A magnetic reed switch or an optical sensor placed on a door of a shipping container can be employed to determine whether the door has been opened after the container was originally sealed for shipment, but it has been shown that such switches and sensors can either be defeated or bypassed. Accordingly, a more effective approach is needed to detect whether a container door has been opened, and optionally, to indicate the date and time it was opened.

It may also be useful to detect if the level, configuration, or volume of the contents within a container has changed while the container is in transit. For example, if some of the contents have been removed after the container was originally packed for shipment, the removed contents may have been replaced with a terrorist device or threat. Or, a terrorist device may have been added to the container while it was in transit. Detecting such changes (particularly, in combination with detecting that the door had been opened) would help to alert authorities of the possibility that the container might hold a threatening device that was introduced while the container door was open. Even detecting changes in the level of a liquid in a container might be useful to determine if a liquid originally held by a shipping container has been replaced with a dangerous liquid, such as a chemical or biological toxin, which is intended to be used in a terrorist attack. Ideally, the same system used for sensing that a door of the container has been opened should also be useful in detecting changes in the volume or in the level of the contents of the container. The system used for such purposes should be relatively low in cost and ideally, should include components that are permanently installed within the interior of the container.

### SUMMARY

To address the issues discussed above, an exemplary method has been developed for detecting whether a door of a shipping container has been opened. The method can thus be employed to avoid a terrorist threat that might arise if a shipping container is opened after leaving its original destination, so that a nuclear, biological, or chemical weapon could be inserted into the shipping container and then activated after the shipping container has entered a U.S. port. The method can also be useful in determining if other possibly undesired changes in the contents of the shipping container have occurred. The method includes the step of producing an ultrasound signal inside the shipping container. This ultrasound signal is propagated along a path that is affected by opening the door of the shipping container. The ultrasound signal is received and detected after it has been propagated along this path, and it is thus possible to determine whether the door has been opened by detecting a change in the ultrasound signal caused by opening the door even a small amount.

The step of producing the ultrasound signal can include the step of producing the ultrasound signal with an ultrasound transducer that is mounted on an inner surface of the door of the shipping container. Accordingly, opening the door changes a direction and length of the path over which the ultrasound signal is propagated.

The method can also include the step of reflecting the ultrasound signal that was produced so that it travels in a different direction. For example, the ultrasound signal can be reflected from a reflector disposed on the door so that if the door is opened, the change in the position of the door changes a path along which the reflector reflects the ultrasound signal. In one exemplary embodiment, the ultrasound signal is reflected from a corner reflector. As is well known, corner reflectors can reflect an ultrasound signal back along a return path that is generally parallel to and in the opposite direction of the path traveled by the ultrasound signal before being reflected from the corner reflector.

In this exemplary method, the step of detecting the change in the ultrasound signal can include the step of detecting a change in a propagation time of the ultrasound signal as the door is opened. The change in the propagation time occurs as a result of a change in a length of the path traveled by the ultrasound signal.

In another exemplary embodiment, a plurality of ultrasound signals are produced and each ultrasound signal is propagated along a different path within the shipping container. Any contents included in the shipping container that intercept one or more of these paths will thereby effect or modify the paths. The plurality of ultrasound signals are then detected after each of the plurality of ultrasound signals has traveled along the different path, and a baseline signal pattern is produced. Any change that has occurred in the paths followed by the plurality of ultrasound signals can be detected by comparing a current signal pattern produced by receiving and detecting the plurality of ultrasound signals, with the baseline signal pattern. Such a change can indicate that a corresponding change has occurred in a configuration of the contents of the shipping container. Accordingly, the change in the configuration can be as a result of either adding or removing at least one item to or from the contents of the shipping container, or as a result of changing an arrangement of the contents of the shipping container.

If the contents of the shipping container comprise a fluid, the change in the configuration that is detected can be as a result of a change in a level of the fluid within the shipping container. Thus, an innocuous liquid that was the original content of the shipping container might be replaced with a liquid comprising a chemical or biological toxin. By detecting the change before this new liquid can be dispersed, the terrorist threat can be avoided.

Any of the exemplary embodiments can further include the step of storing data indicating when any change in the configuration of the contents of the shipping container occurred. Also, data indicating when the door of the shipping container was opened can be stored for later retrieval.

A further aspect of this technology is directed to a memory medium on which machine readable instructions are stored. When executed, these machine instructions cause functions corresponding to the steps of method to be carried out.

Yet another aspect of the present approach is directed to a system configured to be used with a shipping container for detecting whether a door of the shipping container has been opened. This system can thus be retrofitted to an existing shipping container or can be included when the shipping container is originally fabricated or before it is sold to an end user. The system includes an ultrasonic transducer that produces an ultrasound signal, and the ultrasonic transducer is configured to mount within a shipping container and to produce at least one ultrasound signal that is propagated along a path that would be affected by opening a door of the shipping container. Also included in this exemplary embodiment is an ultrasonic receiver that is configured to be mounted inside a shipping container and to detect an ultrasound signal. In response to the ultrasound signal, the ultrasonic receiver produces a corresponding output signal. The ultrasonic receiver is mountable to receive the ultrasound signal propagated along the path that should be affected by opening the door of the shipping container. A logic unit is coupled to the ultrasonic receiver to receive the output signal that it produces and is configured to determine whether the door has been opened by responding to a change in the output signal. Other functions performed by the system are generally consistent with the steps of the method discussed above.

A method and a system using this technology can also specifically be included to detect changes in the configuration of the contents of a shipping container, as discussed above, as well as to detect a level of a fluid (e.g., a liquid) in a shipping container.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is an exemplary schematic top plan view of an interior of a shipping container showing the ultrasound signal paths between door-mounted ultrasonic transducers/receivers and corner reflectors that are disposed along the sides of the shipping container;

FIG. 2 is an exemplary schematic top plan view of an interior of a shipping container showing the multiple ultrasound signal paths followed by multiple ultrasound signals emitted by door-mounted ultrasonic transducers, which are reflected back to ultrasonic receivers by side-mounted corner reflectors;

FIG. 3 is a schematic diagram of a shipping container door and the various parameters that relate to determining that the door has been opened and the extent of the door opening;

FIG. 4 is an isometric view of an exemplary corner reflector illustrating how an ultrasound beam is reflected back along a path that is generally parallel and in the opposite direction relative to the path of an ultrasound signal transmitted toward the corner reflector;

FIGS. 5A and 5B illustrate the relative distances and recorded responses for different degrees of a shipping container door being opened, for door mounted and wall facing ultrasonic transducers/receivers with two wall mounted corner reflectors;

FIGS. 6A and 6B illustrate the relative distances and recorded responses for different degrees of a shipping container door being opened, for door mounted and ceiling facing ultrasonic transducers/receivers with three ceiling mounted corner reflectors;

FIGS. 7, 8, and 9 respectively illustrate bit values for exemplary waveforms in a complex environment, in regard to: (a) single capture raw ultrasonic receiver output data, (b) averaged data, and (c) single capture with match filter data—all based on an ultrasound signal at a frequency of 100 kHz, and a data length of 6,975;

FIG. 10 is an exemplary schematic block diagram and ultrasound signal propagating in a shipping container without interaction with any contents of the shipping container;

FIG. 11 is similar to the FIG. 10, but illustrates the result of the ultrasound signal interacting with contents in the shipping container, to show the change in the ultrasound signal that is received by an ultrasonic receiver;

FIG. 12 is an exemplary schematic plan view of an interior of a shipping container showing the propagation of ultrasound signals between a plurality of ultrasonic transducers/receivers and a plurality of corner reflectors, to detect changes in a configuration of contents of the shipping container;

FIG. 13 is an exemplary functional block diagram showing the components of an ultrasound system that is used to monitor a door open position and/or detect changes in a configuration of the contents of a shipping container;

FIG. 14 is a flowchart illustrating exemplary logical steps for detecting an open door of a shipping container;

FIG. 15 is a flowchart illustrating exemplary logical steps for detecting a change in a configuration of the contents of a shipping container;

FIG. 16 is a schematic cross-sectional side elevational view of a shipping container that includes a liquid, showing how ultrasound is propagated between an ultrasonic transducer/receiver and a corner reflector to detect a change in the amount of liquid in the shipping container; and

FIG. 17 is a side-elevational view of a portion of a shipping container door and top, illustrating an alternative approach for mounting an ultrasonic transducer/receiver to detect when the door is opened based upon a change in an ultrasound signal reflected from the upper doorframe member.

### DESCRIPTION

### Figures and Disclosed Embodiments are Not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

### Exemplary Ultrasound Systems for Monitoring Door of Shipping Container

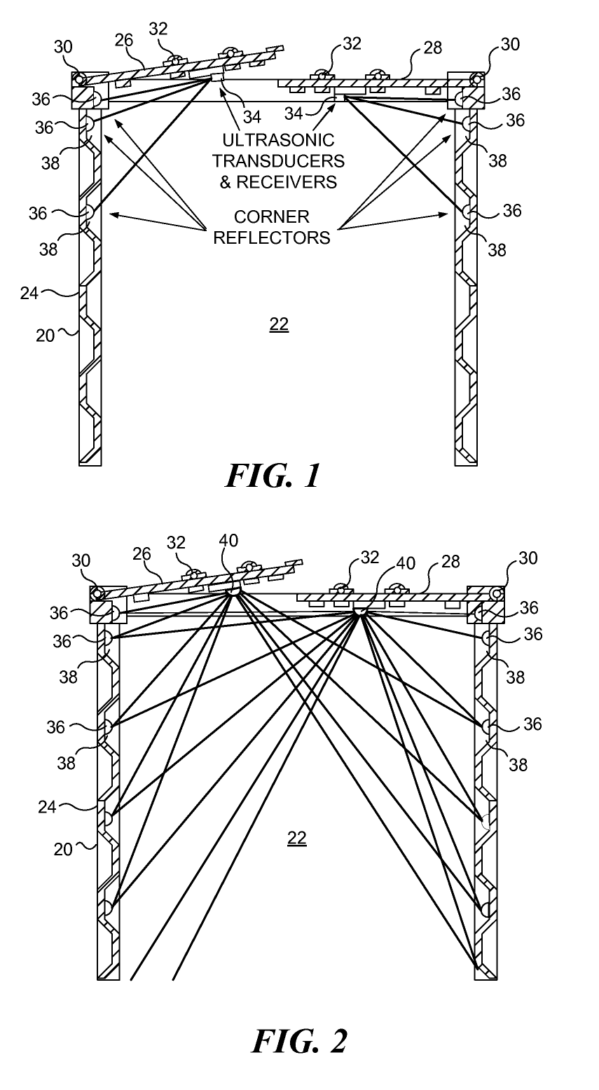

Two exemplary embodiments for using ultrasound to detect that a door of a shipping container has been opened, and even detect the extent that the door was opened are illustrated in FIGS. 1 and 2. In each of these Figures, the portion of a shipping container 20 is illustrated in plan view to indicate how ultrasound signals are propagated between ultrasonic transducers/receivers 34 and corner reflectors 36 within an interior 22 of the shipping container. Shipping container 20 is constructed to include corrugated sheet metal walls 24. A door 26 and a door 28 are included in one end of the shipping container as shown in each of these Figures and are pivotally connected to the sides of the shipping container by hinges 30. Door 26 is first swung outwardly, enabling door 28 to then be opened. The doors are locked in their closed position by engaging latches 32.

As illustrated in FIG. 1, ultrasonic transducers/receivers 34 are mounted on the interior surfaces of each door 26 and 28, and are intended to be left there during the remaining usable life of the shipping container. A suitable adhesive, such as epoxy, or appropriate threaded fasteners that pass through flanges (not shown) of the ultrasonic transducer/receiver and into the underlying surface of the shipping container doors can alternatively be used to mount the devices in place.

Similarly, ultrasonic transducers/receivers 40 are mounted on door 26 and 28 in FIG. 2. Although not separately shown, each of ultrasonic transducers/receivers 34 and 40 includes batteries that are capable of powering the ultrasonic transducers and receivers for periods of up to seven years, depending upon the rate at which the ultrasonic transducers are selectively caused to transmit ultrasound pulses. Also not shown in either of these Figures is the logic unit or processor that controls the ultrasonic transducers/receivers and processes the signal output from the ultrasonic receivers so that door open events can be detected and stored as data that can subsequently be accessed by a user.

As illustrated in FIG. 1, one of the ultrasonic transducers/receivers that is mounted on the interior surface of door 26 (typically near the ceiling to avoid interference caused by the contents of shipping container 20) transmits ultrasonic signals toward corner reflectors 36, which are mounted within valleys 38 of corrugated sheet metal walls 24. The corner reflectors are mounted in the valleys to avoid or minimize the risk of damage that might be caused when loading or unloading the contents of the shipping container. However, corner reflectors 36 that are mounted on the wall adjacent to the hinge for each door are not so well protected, but will be more evident and therefore, less likely to be inadvertently damaged when the contents of the shipping container are loaded or unloaded. The ultrasonic transducers can be set to produce ultrasound pulse signals at a desired repetition rate, which will likely be at least 20 pulses per minute to insure that federal guidelines specifying a three second maximum time interval for detecting that a door is opened are met. However, it should be apparent that other pulse repetition rates can instead be used, as appropriate for a particular application of this technology. Clearly, when a faster pulse repetition rate is selectively set, the battery life for ultrasonic transducers/receivers 34 will be reduced, compared to a slower pulse repetition rate.

As will be evident by inspecting FIG. 1, as door 26 is opened, the length of the path followed by the ultrasound signals between ultrasonic transducer/receiver 34 and corner reflectors 36 will increase, which will be evident in a longer time for the reflected ultrasound signal to be received back by the ultrasonic receiver. The greater the extent to which door 26 is opened, the longer will be the time interval between the transmission and receipt of the ultrasound pulse. Thus, based upon the duration of this delay, it is readily possible to determine the extent that door 26 was opened. It will be understood that the opening of door 28 can also be detected, as well as a determination of the extent to which door 28 is opened. The initial opening of either door can be detected as a result of an increase in the time between the transmission of ultrasound pulses toward each of the corner reflectors and the receipt of the reflected pulses by the ultrasonic receiver.

FIG. 17 illustrates an alternative exemplary embodiment for mounting ultrasonic transducer/receiver 34 so that the ultrasound signal that is produced by the ultrasonic transducer is directed toward a top doorframe member 25, which also supports a top 27 of a shipping container 21. The ultrasound signal is directed through an orifice 23 in the upper portion of the door, but so that it is reflected back from the top doorframe member to the ultrasonic receiver. However, when door 26 is opened, the ultrasound signal is no longer reflected by the top doorframe member, so the output signal of the ultrasonic receiver changes to indicate that the door has been opened. The characteristics of the reflected ultrasound signal can also be used to detect if an attempt is made to employ a different reflective surface after the door is opened to attempt to “spoof” the ultrasound detection system. It will be apparent that many other configurations for mounting ultrasonic transducer/receiver 34 within a shipping container can be employed to detect when a door of the shipping container has been opened, and the disclosed exemplary embodiments are merely intended to show a few examples of how this may be done.

In FIG. 2, ultrasonic transducers/receivers 40 produce and receive a plurality of ultrasound signals that are directed in a plurality of different directions. These signals are reflected back by corner reflectors 36, which are again disposed along the sides of shipping container 20. The greater area coverage provided by ultrasonic transducers/receivers 40 enables them to also detect changes in the configuration of the contents of shipping container 20, as well as detecting the opening of the door. Since the plurality of ultrasound pulses disperse over a wide area within the volume of the shipping container and thereby cover a substantially larger portion of the interior than those produced by ultrasonic transducers/receivers 34 (in FIG. 1), the ultrasound pulse field can readily detect changes in the configuration of the contents of the shipping container if the changes affect the interaction of the ultrasound signals with the contents or change the ultrasound signals that are reflected back to the ultrasonic receivers. Further details describing the use of ultrasound signals for detecting changes in the contents, including changes in the configuration, or the addition or deletion of contents within a shipping container are discussed below.

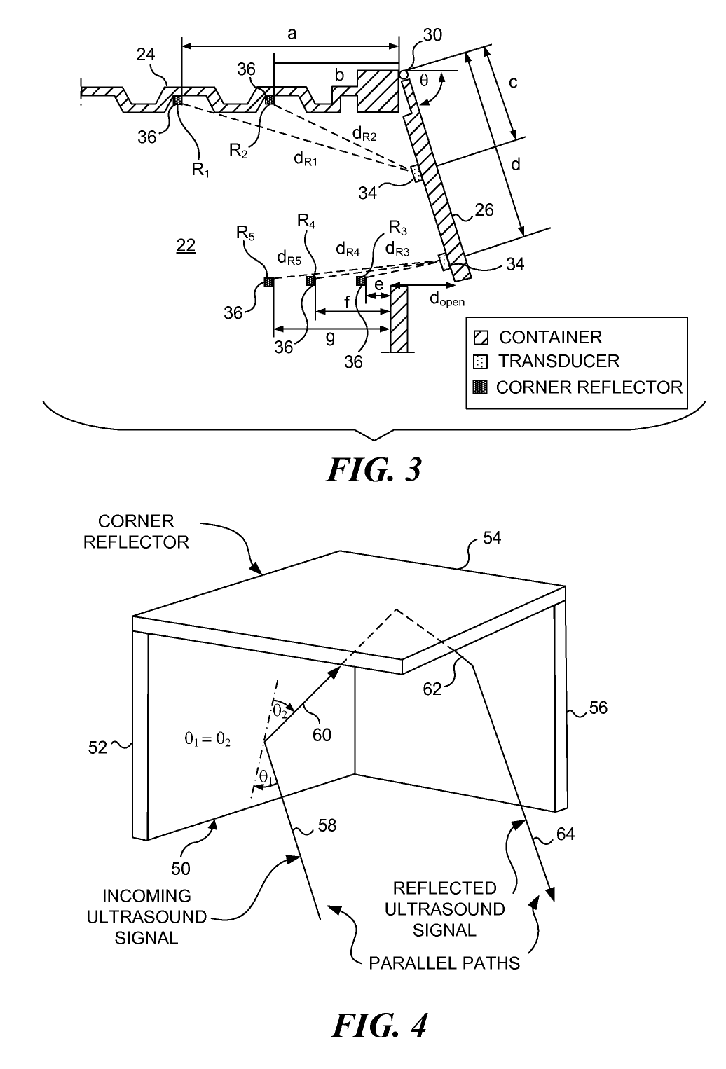

Two exemplary experimental setups to evaluate this approach were constructed, including one with wall mounted corner reflectors, and one with ceiling mounted corner reflectors. FIG. 3 illustrates the two setups and includes identifying reference letters indicating the pertinent geometry of the container and the relationship between the ultrasonic transducers/receivers and corner reflectors mounted therein for each of these two configurations. Wall mounted corner reflectors 34, which are shown in the upper portion of FIG. 3, are generally like those shown in FIGS. 1 and 2 and serve to reflect back the ultrasound signal produced by the ultrasonic transducer, as discussed above. The wall mounted corner reflectors were mounted about 11 inches from the ceiling in this empirical test to minimize the chance that cargo would block the reflections. The ultrasonic transducer/receiver was placed on a door cross beam and angled towards the closest corner reflector 36, so that as the door was opened, the corner reflectors would remain in the beam cone produced by the ultrasonic transducer.

The ceiling mounted corner reflectors (shown in the lower portion of this Figure) were mounted in the valleys on the ceiling corrugation, also tending to protect them from damage during loading and unloading of the contents of the shipping container. The ultrasonic transducer/receiver in this second setup was mounted near the top corner of the door and angled to face the most distant corner reflector so that the corner reflectors would remain in the beam cone as the door was opened. Due to a large lip on the top of the door opening (about 8 inches wide), the closest corner reflector was blocked as the door opened more then a few inches.

In order to understand and evaluate the performance of the door position estimation in this empirical test, it was necessary to develop a model for predicting the response. To this end, a predictive model relating the door position to the echo (reflection) distance was generated from the shipping container door diagram shown in FIG. 3. For example, in regard to the distance parameters indicated in FIG. 3, the predicted echo distance for corner reflector R₂ in the wall mounted corner reflector setup configuration was estimated to be:

d_{R}_{₂}=\sqrt{(b+c cos θ)²+c² sin² θ}

where, d_{R}_{₂} is the distance to the R₂ reflector, θ is the angle of door 26, c is the distance from hinge 30 to the ultrasonic transducer/receiver, and b is the distance from corner reflector R₂ to the door.

In the ceiling mounted corner reflector case, the distance to reflector R₃ is given by:

d_{R}_{₃}=\sqrt{h_{R}_{₃}²+(e+d cos θ)²+(d−d sin θ)²}

where, h_{R}_{₃} is the height difference between the reflector and the door mounted transducer, e is the distance between corner reflector R₃ and the closed door, and d is the distance between the door hinge and the ultrasonic transducer/receiver.

Since the size of the door opening is a more intuitive metric of door position, an estimate relating it to the door angle was approximated by:

θ≈cos⁻¹(d_{Open}/w_{Door})

where, d_{Open} is the distance between the two edges of the doors, with one in a closed position, w_{Door} is the width of the door, and θ is the angle of the door relative to its closed position. With this approximation, the distance to corner reflector R₂ can be simplified to:

d_{R}_{₂}≈\sqrt{2bcd_{Open}/w_{Door}+b²+c²}

The following table illustrates exemplary measured distances for the parameters used in connection with the illustration of FIG. 3.

| Parameter | [in] |
|---|---|
| a | 24 |
| b | 14 |
| c | 11 |
| d | 45 |
| e | 6 |
| f | 14 |
| g | 24 |

While other types of reflectors can be used inside a shipping container to reflect ultrasound signals, when the ultrasonic transducer that emits an ultrasound signal is located immediately next to the ultrasonic receiver that is intended to receive the ultrasound signal back after it is reflected, it will generally be desirable to use a corner reflector. FIG. 4 illustrates an exemplary corner reflector 50. Corner reflector 50 includes three orthogonally oriented and conjoined surfaces 52, 54, and 56. A simple example shown in this Figure illustrates how an incoming ultrasound signal 58 that is incident on surface 52 is reflected along a path 60 toward the underside of surface 54, and reflected from the underside surface along a path 62, before again being reflected from surface 56 along a path 64. Path 64 is generally parallel to, but directed in the opposite direction from that of ultrasound signal 58. Because each reflection of the ultrasound signal is at an angle to the surface equal to the angle of incidence of the ultrasound signal impinging on the surface, the net result is that the reflected ultrasound signal will always be generally parallel to and traveling in the opposite direction from the incoming or incident ultrasound signal, regardless of whether the incoming signal is reflected off two or three of the surfaces of corner reflector 50.

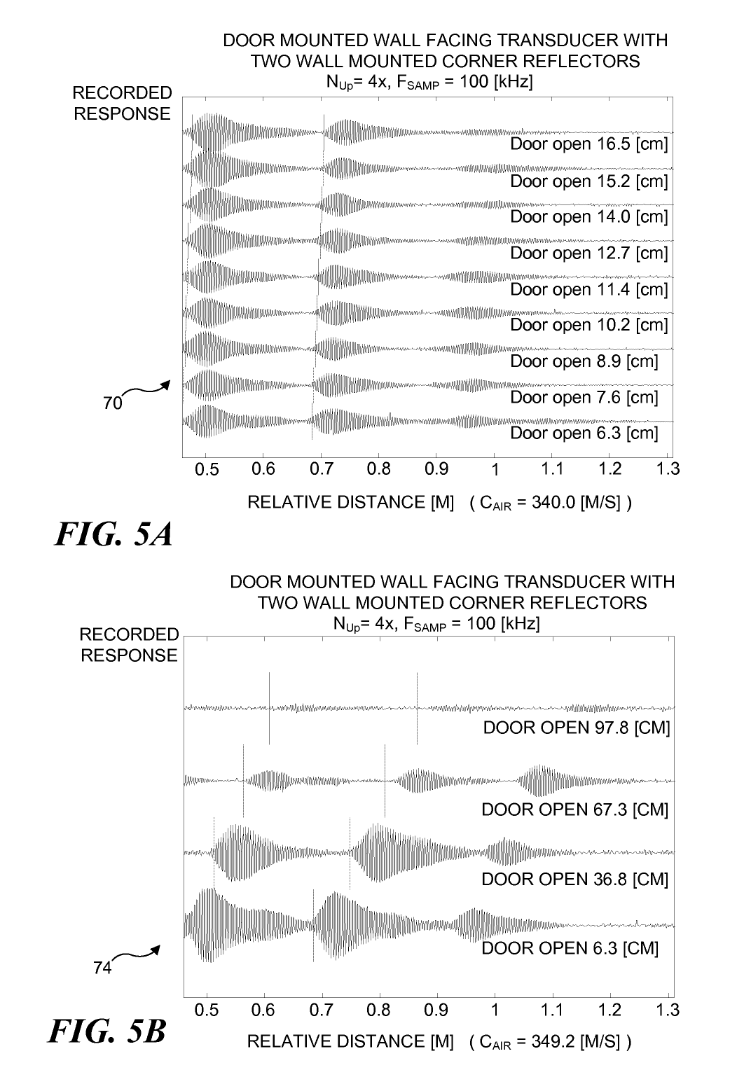

FIGS. 5A and 5B illustrate the recorded responses for different door openings distances for the first case illustrated in FIG. 3, where a door mounted, wall facing ultrasonic transducer is used in connection with two wall mounted corner reflectors. In FIG. 5A, recorded responses 70 illustrate the reflected pulse packets received as reflections from the two wall-mounted corner reflectors as the door is open by different degrees ranging between 6.3 cm and 16.5 cm. Similarly, in FIG. 5B, recorded responses 74 show the reflected pulse packets for door openings in different amounts ranging between 6.3 cm and 97.8 cm. Using the relative distances indicated for the start of each distinctive pulse packet, it is possible to compute the distance that the door was opened for each recorded response, using the equations set forth above.

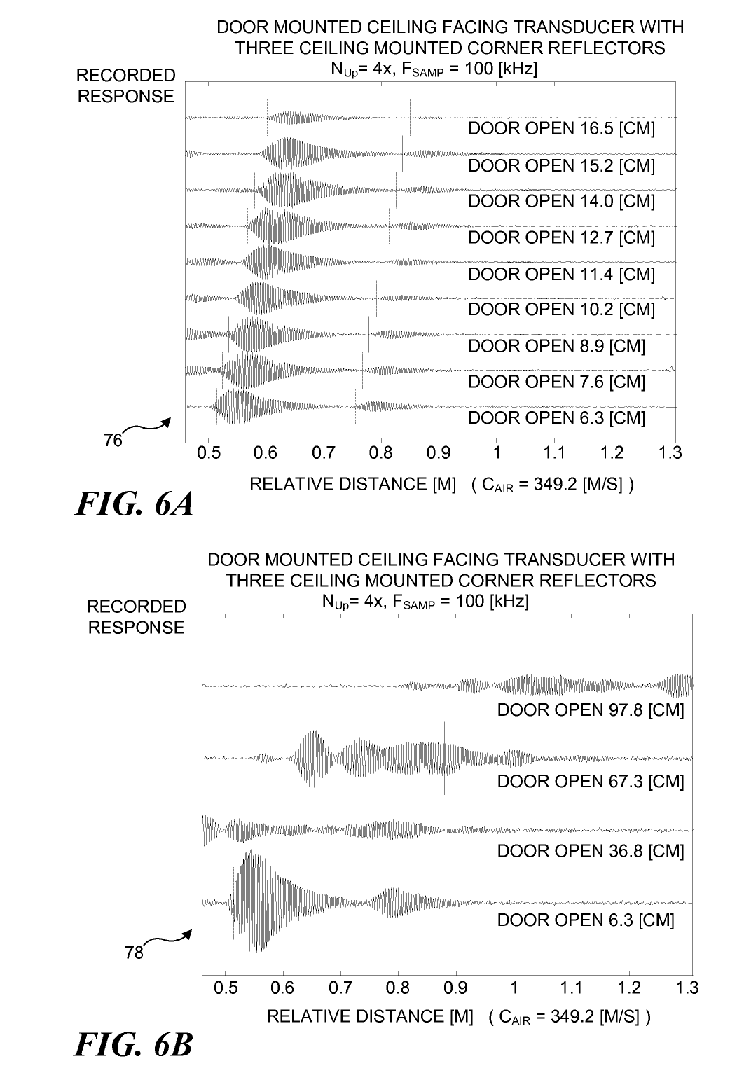

FIGS. 6A and 6B similarly respectively illustrate recorded responses 76 and 78, showing the pulse packets received at different door opening distances in connection with the door mounted, ceiling facing ultrasonic transducers, and using three ceiling mounted corner reflectors. Recorded responses 76 illustrate pulse packets at door opening extents ranging from 6.3 cm through 16.5 cm, while recorded responses 78 indicate pulse packets for door opening extents ranging between 6.3 cm and 97.8 cm.

### Using Ultrasound Signals to Detect Changes in the Contents of Shipping Container

While potential terrorist threats can be detected simply by detecting that the door of a shipping container has been opened, it is desirable to also determine if the contents of a shipping container have been changed in some way. Changes that might be detected with ultrasound signals include the addition of an item to the contents, or the removal of an item, or a change in the configuration of the contents. If the door of a shipping container has been opened while it is in transit from its originating port, and if the contents of the shipping container have changed in some manner, then there is a much higher justification for investigating the shipping container before it is allowed to enter this country and offloaded from the ship in which it enters a port. The combined indications of an opened door and a change in the contents of a shipping container are clearly of greater concern than the determination alone that the door was opened, or only determining that the contents have changed in some manner. It is possible for the configuration of contents to shift due to the ship being exposed to rough weather, or due to improper handling, but not as a result of a potential terrorist threat. However, if the door was opened and the contents appear to have changed at about that point in time, there is a very strong justification to investigate the shipping container more thoroughly.

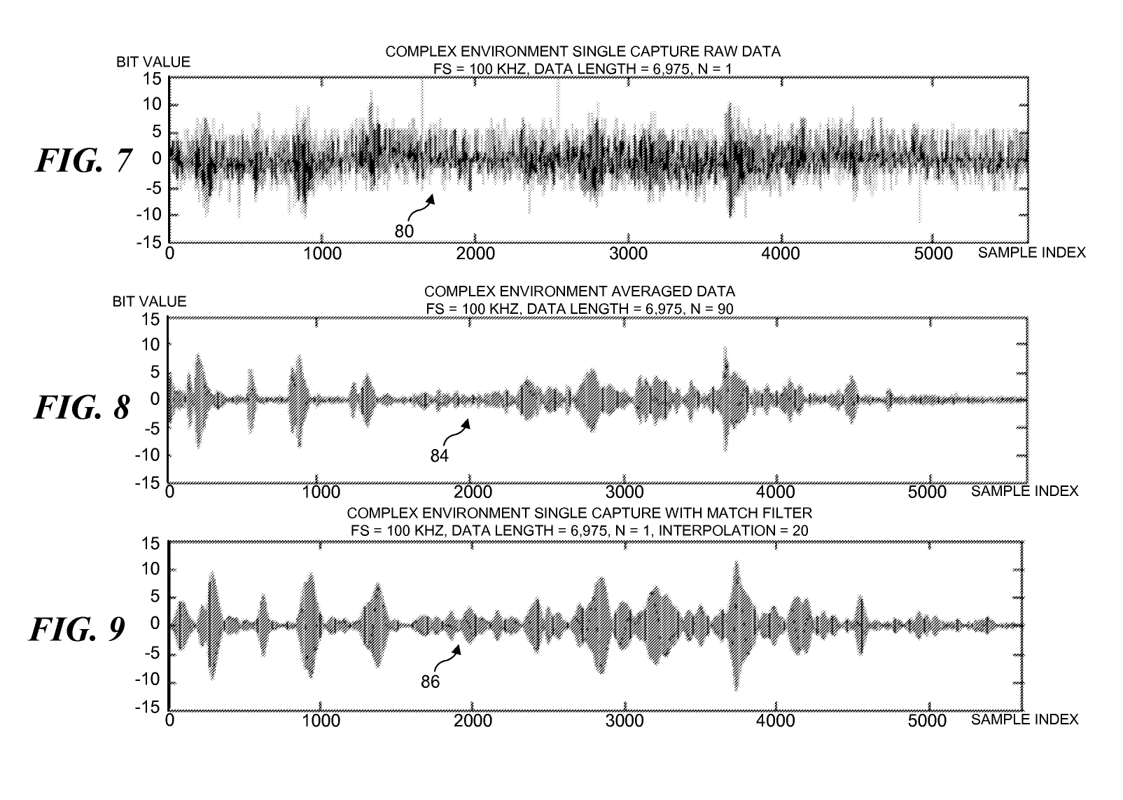

FIGS. 7, 8, and 9 illustrate different forms of the ultrasound signal that is received by an ultrasonic receiver after ultrasound signals have propagated through a relatively complex environment inside a shipping container and have interacted with one or more objects included in the contents. In FIG. 7, an exemplary raw output signal 80 from an ultrasonic receiver is illustrated. This raw output signal can be averaged to produce an averaged signal 84, which is shown in FIG. 8. Finally, the averaged signal can be further processed using a match filter, resulting in a match filtered signal 86, as shown in FIG. 9.

Clearly, either the raw, the averaged, or the match filtered signals can be used as a baseline signal pattern that is detected and saved immediately after the shipping container has been loaded with its contents and the doors closed. Subsequently, any change in the signal pattern that is detected, by comparison with the baseline signal pattern, can be used to detect that the contents of the shipping container have been changed, either by adding one or more items, removing one or more items, or changing the configuration of the items included therein. If such a change is detected shortly after an opening of the door of the shipping container has been detected, the combined evidence can provide a strong justification for further investigation.

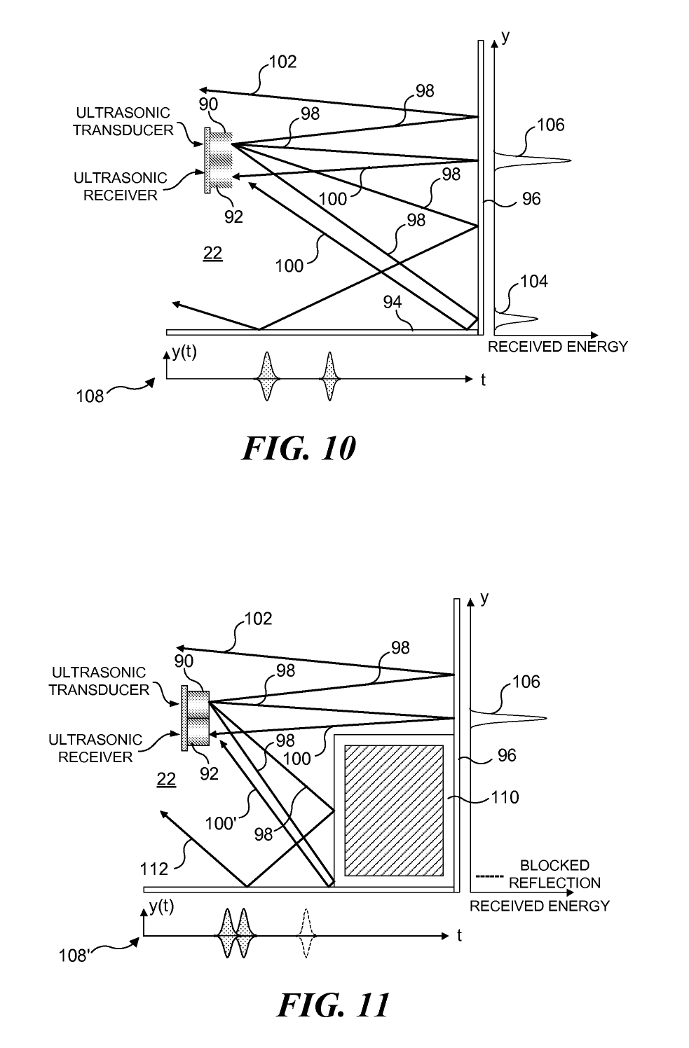

To better illustrate the concept of how ultrasound signals can be employed to detect changes in the content of a shipping container, FIG. 10 shows a schematic diagram of a portion of shipping container 22 where there is no carton interacting with ultrasound signals 98 that are transmitted from an ultrasonic transducer 90. These ultrasound signals are reflected by surfaces 94 and 96 of the shipping container, producing reflected ultrasound signals 100 that are received by an ultrasonic receiver 92. In addition, reflected ultrasound signals 102 in the shipping container are not received because their return path does not reach the ultrasound receiver. A baseline signal pattern 108 results from the return ultrasound signals that are detected by the ultrasound receiver, which correspond to the energy pulses 104 and 106 shown to the side of the FIGURE.

In FIG. 11, interior 22 of the shipping container now includes a box 110, which interacts with ultrasound signals 98, for example, producing reflected ultrasound signals 100′ and 112, and thus, producing a new or current signal pattern 108′ that clearly differs from the baseline signal pattern 108 that was stored when box 110 was not interacting with the ultrasound signals. The clear difference in the current signal pattern is the result of the blocked reflection shown at the right of the FIGURE, since energy pulse 104 is no longer detected. By comparing the current signal pattern with the baseline signal pattern and detecting that a significant change (e.g., greater than a predefined minimum) has occurred, it is possible to detect that a change in the contents of the shipping container has occurred. The time at which this change in the contents or configuration occurred can also be determined and included with the data that are stored and can subsequently be accessed. Optionally, when a change in the contents is detected, an audible, visual, radio signal transmission, and/or some other form of alert can be provided. Thus, if only a few individuals aboard a ship were involved in opening a shipping container to insert a terrorist weapon, the alarm being activated would alert the other persons on the ship to investigate the cause of the alarm.

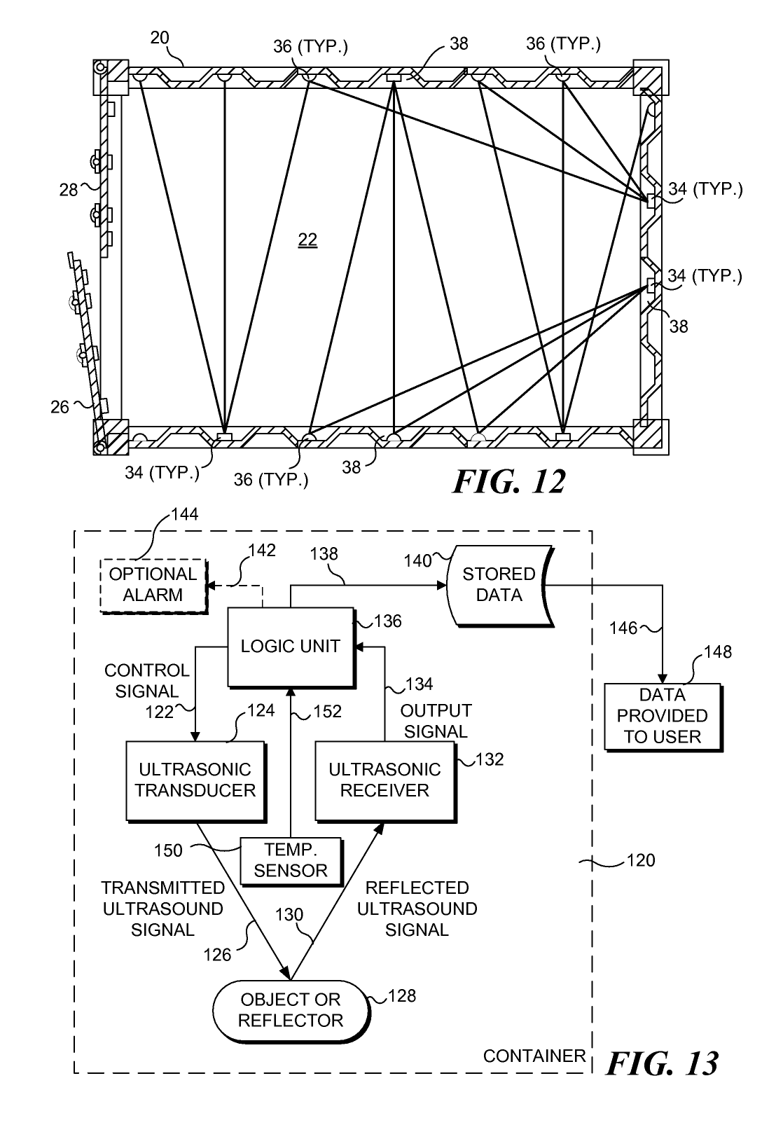

As discussed above, it is possible to use the same ultrasonic transducers and receivers to both detect the opening of a door of a shipping container, and to detect a change to the contents of the shipping container. However, a separate ultrasound system can be employed just to detect changes in the contents of the shipping container, independent of the door being opened. FIG. 12 illustrates an exemplary embodiment of such an ultrasound system. In this exemplary embodiment, two ultrasonic transducers/receivers 34 are disposed at spaced apart location near the ceiling, along one side (i.e., a first side) of the shipping container, one transducer/receiver 34 is disposed near the ceiling along the opposite side (a second side) to provide ultrasound path coverage between that provided by the other two ultrasonic transducers/receivers on the first side, and two additional ultrasonic transducers/receivers 34 are disposed at spaced apart locations near the ceiling on the end wall, i.e., on the wall opposite from where doors 26 and 28 are disposed. The ultrasound signals produced by the ultrasonic transducers are directed through interior 22 of the shipping container toward corner reflectors 36 disposed at spaced apart locations near the ceiling on the side walls of the shipping container. All of ultrasonic transducers/receivers 34 and corner reflectors 36 are mounted within valleys 38 of the corrugated sheet metal comprising the walls and end of the shipping container, to provide protection against damage that might occur when the contents of the shipping container are loaded or unloaded. The ultrasound signals produced by the ultrasonic transducers thus cover virtually the entire area of the shipping container and are reflected back to the corresponding ultrasonic receiver by the corner reflector as shown, unless a container or other object within the path interferes with the ultrasound signal.

Most shipping containers are packed with cartons or other objects very efficiently, leaving only a small region at the top that may be free of the contents. It is this region that can readily be monitored by the arrangement shown in FIG. 12, since the ultrasound signals are propagating within interior 22 of the shipping container near the ceiling. The actual depth covered below the ceiling can be selectively determined by the elevations at which the ultrasonic transducers/receivers and corner reflectors are mounted.

It should be understood that the numbers and locations of ultrasonic transducers/receivers 34 and corner reflectors 36 that are employed in a shipping container can be very different than the exemplary embodiment illustrated in FIG. 12, and the configuration of this system is only intended to be one example of many different configurations for such a system. For example, it may be desirable to monitor the lower portion of a shipping container that is supposed to be empty, to detect when something has been added to the shipping container. This function can readily be achieved by providing one or more additional ultrasonic transducers/receivers and corner reflectors at a lower elevation in the shipping container or by angling the paths of the ultrasound signals so that they cover the lower portions of the shipping container.

### Hardware Components of Exemplary Ultrasound System

FIG. 13 illustrates an exemplary functional block diagram of at least a portion of an ultrasound system that can be used to detect a door of a shipping container 120 being opened and/or to detect a change in the contents of the shipping container. A control signal 122 is provided by a logic unit 136 to an ultrasonic transducer 124 each time that an ultrasound pulse signal 126 is to be transmitted within the interior of the shipping container. Alternatively, the control signal may not be required if the ultrasonic transducer is instead designed to produce ultrasound pulses at a set or selectable predefined interval. As a further alternative, the control signal might only initiate the start of consecutive ultrasound pulses that continue until commanded to stop by another control signal.

Ultrasound signal 126 is reflected either by a surface, an object, or a reflector (e.g., a corner reflector) 128, producing a reflected ultrasound signal 130 that is propagated back to an ultrasonic receiver 132. In response to receiving the reflected ultrasound signal, ultrasonic receiver 132 produces a corresponding output signal 134, which is input to logic unit 136 for processing. A temperature sensor 150 produces a temperature signal 152 that is also input to the logic unit, so that the output signal from the ultrasonic receiver can be compensated for the temperature inside the shipping container, since this temperature affects the speed of sound in air, which will thus affect the distance or range determined for a reflected ultrasound signal. The logic unit can be any type of a variety of different logic devices, including for example, a single or multi-chip microcomputer integrated circuit, an applications specific integrated circuit (ASIC), a programmable logic array, etc. If the logic unit processes the output signal and determines that the output signal represents an event of interest, such as an opening of the door of the shipping container, or a change of the ultrasound pattern from the baseline signal pattern indicating a change in the contents of the shipping container, it records an event 138 as stored data 140 and optionally, also records the time/date of the event as part of the stored data (assuming that the logic unit has the capability to determine the time/date and is caused to do so). As a further option, detecting such an event of interest can cause an alarm signal 142, which cause an alarm 144 such as an audible alarm, a visual alarm (blinking light), a radio transmission, and/or other alert signal to be produced, to indicate that the event has been detected. The stored data can be recorded in non-volatile memory, or other suitable memory storage.

A combined device that includes an ultrasonic transducer and receiver in one integral package is available and is known as the X-Coupler™. This device is available for just a few dollars each. Other similar devices are available for even less cost. It should also be understood that the ultrasonic transducer that emits ultrasound can be disposed at a different location from the ultrasonic receiver that receives the ultrasound signal after it has been reflected from a reflector, a surface, or an object.

At an appropriate time (typically before the shipping container is offloaded from the ship in which it is transported), a user can query the stored data over a line 146, to access any data that might be stored indicating that an event of interest was detected. This data can indicate whether, and when, and to what extent a door of the shipping container was opened, and can indicate that a change in the contents of the shipping container was detected and the date/time it was detected. A user can access the stored data either wirelessly, e.g., over a Bluetooth or other type of radio frequency data connection, or by directly electronically connecting to the stored data and downloading any such data that are included therein.

### Exemplary Logical Steps for Implementing Procedures

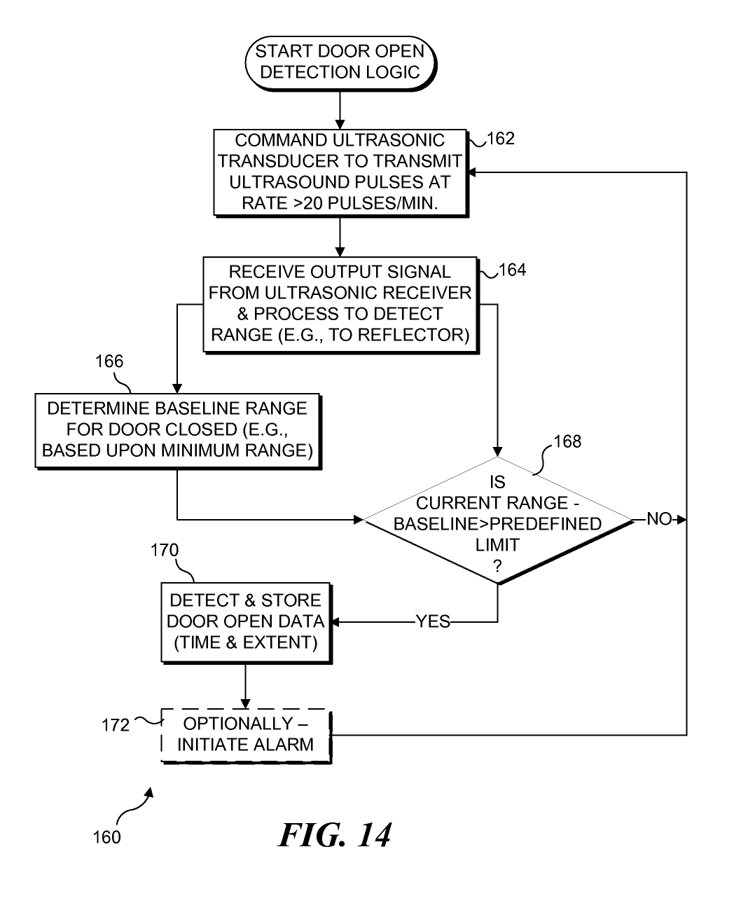

FIG. 14 illustrates exemplary logical steps 160 for carrying out the process of detecting whether a door of a shipping container has been opened. After the process starts, for example, after the door is closed at the time the shipping container is sealed for shipment, a step 162 commands the ultrasonic transducer to transmit (or at least initiate transmission of) ultrasound pulses at a desired repetition rate, e.g., at a repetition rate greater than about 20 pulses per minute so that there is less than three seconds between successive ultrasound pulses. A step 164 provides for receiving the output signal from an ultrasonic receiver that has received a reflected ultrasound pulse within the shipping container. The output signal is processed, e.g., by compensating it for the temperature inside the shipping container, averaging the output signal, and applying a match filter to the averaged signal.

For an initial output signal detected shortly after the shipping container was sealed at its point of origin, a step 166 provides for determining a baseline range for the door in its closed state, or this baseline data can be determined using a minimum range between the door and the reflector. A decision step 168 subsequently determines if the difference between current range or distance to the door (i.e., relative to the distance between the ultrasonic transducer and the reflector that reflects the ultrasound signal) and the baseline range is greater than a predefined limit. Baseline ranges can be determined for each of a plurality of different reflectors, and the differences between the current range and the corresponding baseline range can then be determined for each reflector to reach a determination in decision step 168. If the difference is greater than the predefined limit, which is selected to provide some margin for acceptable variations in the measurement, an affirmative response results in a step 170 detecting and storing the door open event data, as well as the date/time and the extent of door opening, if possible and desired. An optional step 172 can also be provided to initiate an alarm signal, which can comprise any desired form of a human perceptible alert signal. If the result of decision step 168 is negative or following optional alarm initiation step 172, the logic loops back to step 162.

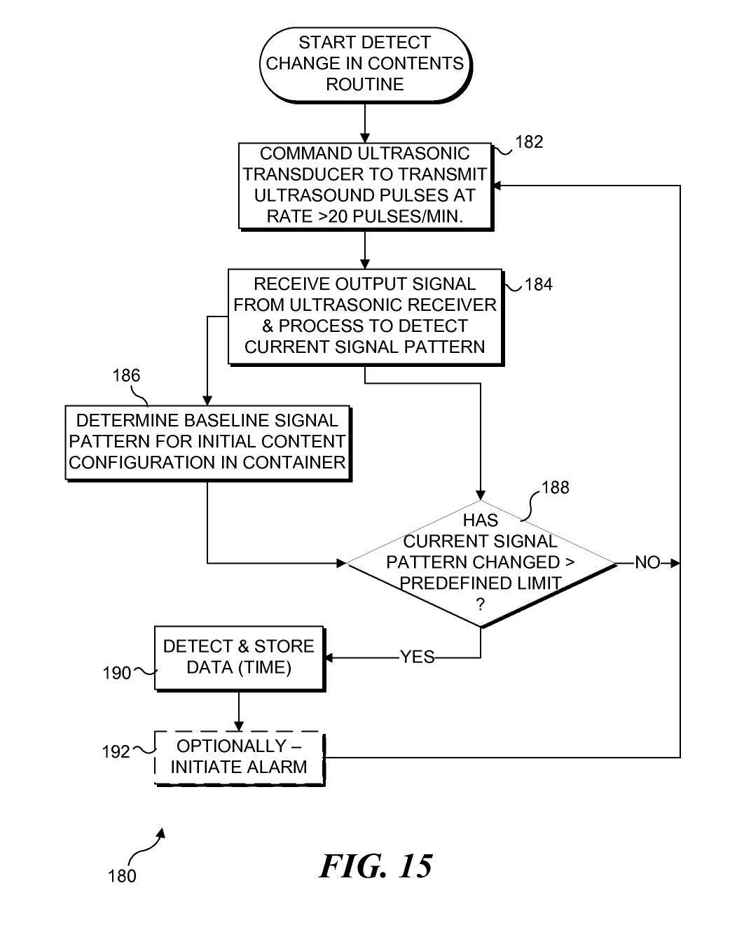

A similar flowchart 180 showing exemplary logical steps for detecting a change in the contents of a shipping container is illustrated in FIG. 15. After the process starts, e.g., following the sealing of the shipping container at its port of origin, a step 182 is carried out to initiate the transmission of ultrasound pulses, just as in step 162 of FIG. 14. Similarly, a step 184 provides for receiving and processing the output signal from an ultrasonic receiver to detect a current signal pattern, generally as in step 164 from FIG. 14. At some time shortly after the shipping container was sealed, a step 186 determines a baseline signal pattern for the initial content configuration of the shipping container and records this baseline signal pattern in a non-volatile memory. Thereafter, a decision step 188 determines if any subsequent new current signal pattern has changed from the baseline signal pattern by more than a predefined limit and if so, a step 190 stores data to record the event, including the date/time, if possible and desired. An optional alarm signal is produced in a step 192, generally as discussed above. After step 192, or if the result of decision step 188 is negative, the logic loops back to step 182. It will be understood that either the logic of FIG. 14, or the logic of FIG. 15 can be implemented, or both.

### Detecting Changes in Fluid Level

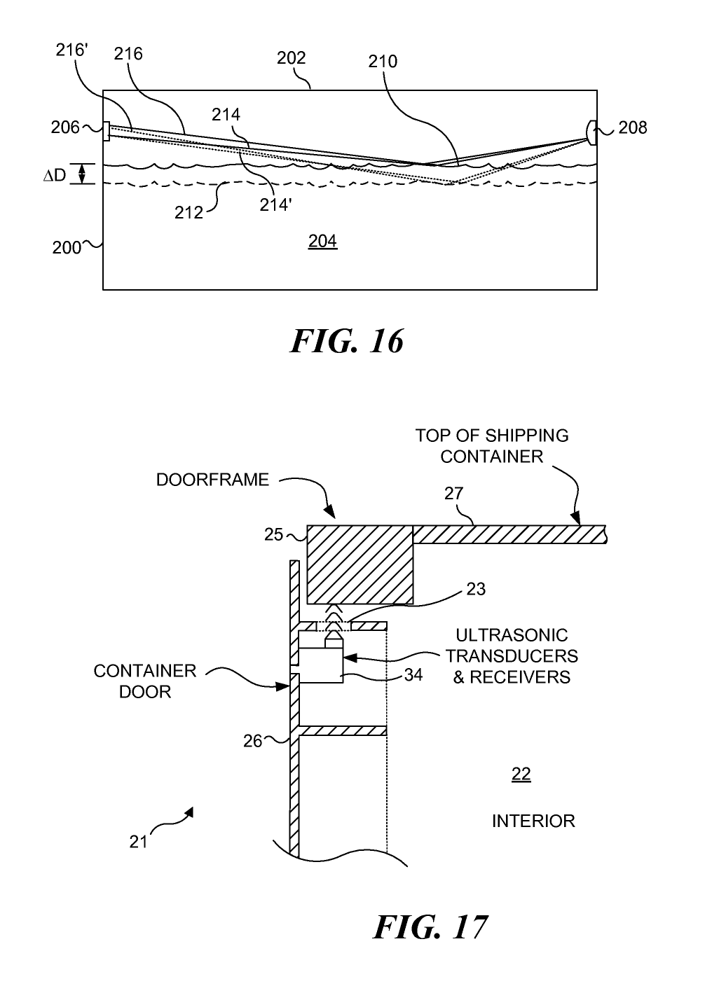

FIG. 16 illustrates yet another way in which ultrasound signals can be employed to detect changes in the contents of a shipping container. In this example, a shipping container 200 comprising a fluid housing 202 is shown holding a fluid 204 (likely a liquid—but not necessarily) within the fluid housing. An ultrasonic transducer/receiver 206 is mounted in the interior at one end of the fluid housing, while a reflector 208 (e.g., a corner reflector) is mounted in the interior of the housing at the opposite end. A current level 210 of the fluid serves to reflect an ultrasound signal 214 that is transmitted by the ultrasonic transducer toward reflector 208, which reflects the ultrasound signal back from the surface of the fluid toward the ultrasonic receiver, as a return ultrasound signal 216. Furthermore, a different baseline fluid level 212 may previously have been detected when the shipping container was originally filled with a fluid. When the baseline fluid level was determined, an ultrasound signal 214′ was reflected from the surface of the fluid toward the reflector and then received after being reflected by the reflector and then from the surface of the liquid at level 212 to form a return signal 216′.

If a substantial change in depth, AD, is subsequently detected between the baseline fluid level and the current fluid level, then the detected change can be noted and recorded as event data, along with a date/time of the event, if possible and desired. The change in the depth of the fluid in the shipping container might be an indication that a relatively innocuous fluid originally pumped into the shipping container has been removed and replaced with a dangerous fluid that might be used in a terrorist attack. For example, a biological or chemical threat might have been loaded into the shipping container as a fluid to subsequently be dispersed in high population areas once the shipping container enters the U.S. at a port of call and is off loaded from a ship. By detecting the change in depth, authorities can be alerted to investigate the contents of the shipping container before the threat can be deployed in this country.

The level of fluids other than a liquid (such as gases) can also be detected by ultrasound. For example, if the fluid is relatively dense compared to another fluid above it, the interface between a dense fluid and the overlying layer of air or other type of lower density gas can reflect ultrasound so that the depth of a gaseous fluid and changes in the depth can be detected with the ultrasound signal, as generally shown in FIG. 16.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A method for detecting whether a door of a shipping container has been opened, comprising the steps of:
(a) producing an ultrasound signal inside of the shipping container, wherein the ultrasound signal is propagated along a path that is affected by opening the door of the shipping container;
(b) receiving and detecting the ultrasound signal after it has been propagated along the path that is affected by opening the door; and
(c) determining that the door has been opened by detecting a change in the ultrasound signal occurring because the door was opened.

2. The method of claim 1, wherein the step of producing the ultrasound signal comprises the step of producing the ultrasound signal with an ultrasound transducer that is mounted on an inner surface of the door of the shipping container, so that opening the door changes a direction in which the ultrasound signal is propagated.

3. The method of claim 1, further comprising the step of reflecting the ultrasound signal that was produced in a different direction.

4. The method of claim 3, wherein the step of reflecting comprises the step of reflecting the ultrasound signal from a reflector disposed on the door so that opening the door changes a path along which the reflector reflects the ultrasound signal.

5. The method of claim 3, wherein the step of reflecting the ultrasound signal comprises the step of reflecting the ultrasound signal from a corner reflector that reflects the ultrasound signal back along a return path that is generally parallel to and in the opposite direction relative to the path traveled by the ultrasound signal before being reflected from the corner reflector.

6. The method of claim 1, wherein the step of detecting the change in the ultrasound signal comprises the step of detecting a change in a propagation time of the ultrasound signal as the door is opened, as a result of a change in a length of the path traveled by the ultrasound signal.

7. The method of claim 1, further comprising the steps of:
(a) producing a plurality of ultrasound signals, each of the plurality of ultrasound signals being propagated along a different path within the shipping container, so that any contents included in the shipping container modify one or more of the paths followed by the plurality of ultrasound signals;
(b) receiving and detecting the plurality of ultrasound signals after each of the plurality of ultrasound signals has traveled along the different path, producing a baseline signal pattern; and
(c) detecting whether a change has occurred in the paths followed by the plurality of ultrasound signals by comparing a current signal pattern produced by receiving and detecting the plurality of ultrasound signals, with the baseline signal pattern, a change in the paths followed by the plurality of ultrasound signals indicating that a change has occurred in a configuration of contents of the shipping container.

8. The method of claim 7, wherein the change in the configuration that is detected is a result of either adding at least one item to the contents of the shipping container, or removing at least one item from the shipping container, or changing an arrangement of the contents of the shipping container.

9. The method of claim 7, wherein the contents of the shipping container comprise a fluid, and wherein the change in the configuration that is detected is a result of a change in a level of the fluid within the shipping container.

10. The method of claim 7, further comprising the step of storing data indicating when any change in the configuration of the contents of the shipping container occurred.

11. The method of claim 1, further comprising the step of storing data indicating when the door of the shipping container was opened.

12. A memory medium on which machine readable instructions are stored, which when executed, carry out the steps of claim 1.

13. A system configured to be used with a shipping container for detecting whether a door of the shipping container has been opened, comprising:
(a) an ultrasonic transducer that produces an ultrasound signal, the ultrasonic transducer being configured to mount within a shipping container and to produce at least one ultrasound signal that is propagated along a path affected by opening a door of the shipping container;
(b) an ultrasonic receiver that is configured to be mounted inside a shipping container and to detect an ultrasound signal and to respond by producing a corresponding output signal, the ultrasonic receiver being mountable to receive the ultrasound signal that is propagated along the path affected by opening the door of the shipping container; and
(c) a logic unit that is coupled to the ultrasonic receiver to receive the output signal produced by the ultrasonic receiver, the logic unit being configured to determine whether the door has been opened by responding to a change in the output signal from the ultrasonic receiver occurring because the door was opened.

14. The system of claim 13, wherein the ultrasonic transducer is configured to be mounted on an inner surface of the door of a shipping container, so that when the door is opened, a direction of the path along which the ultrasound signal produced by the ultrasonic transducer propagates changes, which causes the output signal of the ultrasonic receiver that is receiving the ultrasound receiver to change.

15. The system of claim 13, further comprising at least one reflector that is configured to be mounted inside a shipping container and to reflect the ultrasound signal produced by the ultrasonic transducer in a different direction.

16. The system of claim 15, wherein the at least one reflector is configured to be mounted on the door of a shipping container in a position so that opening the door changes a path along which the reflector reflects the ultrasound signal.

17. The system of claim 15, wherein the at least one reflector comprises a corner reflector that reflects the ultrasound signal back along a return path that is generally parallel to and in the opposite direction relative to the path traveled by the ultrasound signal before being reflected from the corner reflector.

18. The system of claim 13, wherein the logic unit is further configured to detect a change in a propagation time of the ultrasound signal as the door is opened, as a result of a change in a length of the path traveled by the ultrasound signal.

19. The system of claim 13, further comprising:
(a) at least one additional ultrasonic transducer, adapted to be mounted inside a shipping container, for producing at least one additional ultrasound signal that propagates within the shipping container; and
(b) at least one additional ultrasonic receiver, adapted to be mounted inside a shipping container and coupled to the logic unit, for receiving the at least one additional ultrasound signal that has propagated within the shipping container and producing at least one corresponding output signal conveyed to the logic unit, whereby all of the ultrasound signals produced in the shipping container propagate over a larger area within the shipping container than a single ultrasound signal.

20. The system of claim 19, wherein the at least one corresponding output signal produced by at least one of the ultrasonic receiver, in response to receiving the at least one additional ultrasound signal propagating within a shipping container, is used by the logic unit to determine a baseline signal pattern that can be used to detect a change in a configuration of contents of the shipping container.

21. The system of claim 20, wherein the logic unit is able to detect a change in the configuration of the contents of a shipping container by comparison of a current signal pattern produced using the at least one corresponding output signal, with the baseline signal pattern, where the contents of the shipping container interact with the at least one additional ultrasound signal, so that a change in the configuration alters the at least one corresponding output signal produced by the at least one additional ultrasonic receiver.

22. The system of claim 21, wherein the corresponding output signal produced by the at least one additional ultrasonic receiver is used by the logic unit to detect whether at least one item has been added to the contents of the shipping container, or at least one item has been removed from the shipping container, or an arrangement of the contents of the shipping container has been changed.

23. The system of claim 21, wherein the contents of the shipping container comprise a fluid, and wherein the change in the configuration that is detected is a result of a change in a level of the fluid within the shipping container.

24. The system of claim 21, further comprising a memory medium that is coupled to the logic unit, so that the logic unit is enabled to store data in the memory medium indicating when any change in the configuration of the contents of a shipping container occurred.

25. The system of claim 13, further comprising a memory medium that is coupled to the logic unit, so that the logic unit is enabled to store data in the memory medium indicating when the door of a shipping container was opened.

26. A method for detecting a change in a configuration of contents of a shipping container, comprising the steps of:
(a) producing an ultrasound signal that propagates over an area within the shipping container, so that ultrasound signal is expected to interact with any contents of the shipping container;
(b) detecting the ultrasound signal after it has propagated within the shipping container and interacted with the contents, producing an output signal corresponding to the ultrasound signal that was detected; and
(c) determining that a configuration of the contents has changed based upon the output signal.

27. The method of claim 26, wherein the step of determining that the configuration of the contents has changed comprises the steps of:
(a) producing a baseline signal pattern based upon the output signal; and
(b) comparing the baseline signal pattern with a subsequent signal pattern produced from the output signal, to detect a change from the baseline signal pattern indicating that the configuration of the contents has changed.

28. The method of claim 26, wherein the step of producing the ultrasound signal comprises the step of producing multidirectional ultrasound signals that propagate in different directions, over a substantial area within the shipping container.

29. The method of claim 26, further comprising the step of reflecting the ultrasound signal propagating within the shipping container with a reflector.

30. The method of claim 29, wherein the step of reflecting comprises the step of using a corner reflector for reflecting the ultrasound signal back along a path that is substantially parallel to a path followed by the ultrasound signal toward the corner reflector, but in an opposite direction.

31. The method of claim 26, wherein the ultrasound signal propagates over a path that is adjacent to a ceiling of the shipping container.

32. The method of claim 26, wherein a change in the configuration is detected as a result of a change in the ultrasound signal that is detected if at least one item is added to the contents of the shipping container, or at least one item is removed from the contents of the shipping container, or an arrangement of the contents of the shipping container is changed.

33. The method of claim 26, wherein the contents of the shipping container comprise a fluid, and wherein the step of detecting a change in configuration comprises the step of detecting a change in a level of the fluid within the shipping container based upon a change in the ultrasound signal that is reflected from the fluid.

34. A system for detecting a change in a configuration of contents of a shipping container, comprising:
(a) an ultrasonic transducer that produces an ultrasound signal, the ultrasonic transducer being configured to mount within a shipping container and to produce at least one ultrasound signal that is propagated over an area inside a shipping container;
(b) an ultrasonic receiver that is configured to be mounted inside a shipping container and to detect an ultrasound signal and to respond by producing a corresponding output signal, the ultrasonic receiver being mountable to receive the ultrasound signal that is propagated; and
(c) a logic unit that is coupled to the ultrasonic receiver to receive the output signal produced by the ultrasonic receiver, the logic unit being configured to determine whether a change in a configuration of contents within the shipping container has occurred based upon a change in the output signal produced by the ultrasonic receiver.

35. The system of claim 34, wherein the ultrasonic transducer is configured to be mounted within the shipping container so that the ultrasound signal propagates through a portion of the shipping container that is likely to include contents that will interact with the ultrasound signal, so that any change in the configuration of the contents will change the output signal produced by the ultrasonic receiver.

36. The system of claim 34, wherein the output signal of the ultrasonic receiver is used by the logic unit to produce a baseline signal pattern that is compared with a current signal pattern by the logic unit to detect a change in the signal pattern caused by any change in the configuration of the contents of the shipping container.

37. The system of claim 34, further comprising at least one additional ultrasonic transducer configured to be mounted within a shipping container, for producing at least one additional ultrasound signal for propagation within the shipping container.

38. The system of claim 34, wherein the ultrasonic transducer produces multidirectional ultrasound signals that propagate in different directions, over a substantial area within a shipping container.

39. The system of claim 34, further comprising at least one reflector that reflects the ultrasound signal produced by the ultrasonic transducer, substantially changing the direction of the ultrasound signal.

40. The system of claim 39, wherein the at least one reflector comprises at least one corner reflector that reflects the ultrasound signal back along a path that is substantially parallel to a path followed by the ultrasound signal toward the corner reflector, but generally in an opposite direction.

41. The system of claim 34, wherein the ultrasonic transducer is configured to be mounted so that the ultrasound signal is propagated over a path that is at a height within the shipping container where the ultrasound signal is likely to interact with the contents of the shipping container.

42. The system of claim 34, wherein a change in the configuration is detected by the logic unit if the ultrasound signal is affected by adding at least one item to the contents of the shipping container, or by removing at least one item from the contents of the shipping container, or by changing an arrangement of the contents of the shipping container.

43. The system of claim 34, wherein the contents of the shipping container comprise a fluid, and wherein the step of detecting a change in configuration comprises the step of detecting a change in a level of the fluid within the shipping container based upon a change in the ultrasound signal that is reflected from the fluid.

44. A method for detecting a change in a level of a fluid in a shipping container, comprising the steps of:
(a) transmitting an ultrasound signal from an ultrasonic transducer disposed in the shipping container;
(b) reflecting the ultrasound signal from a corner reflector disposed in the shipping container;
(c) receiving the ultrasound signal with an ultrasonic receiver after the ultrasound signal has been reflected from a surface of the fluid in the shipping container;
(d) in response to the ultrasound signal that was received, producing an output signal indicative of a level of the fluid in the shipping container; and
(e) detecting a change in the level of the fluid in the shipping container, by comparison of a current level with a previously determined level.

45. The method of claim 44, wherein the fluid is a liquid, and the step of determining the level of the fluid comprises the step of averaging successive values for the level determined that are approximately the same, to account for variations caused by movement of the liquid during transport.

46. The method of claim 44, further comprising the step of saving at least a time that the level of the fluid in the container was found to have changed.

47. The method of claim 44, wherein the step of detecting a change in the level of the fluid in the shipping container comprises the step of detecting that the level has changed only if the current level is found to differ from the previously determined level by more than a predefined minimum amount.

48. The method of claim 44, further comprising the step of compensating the determination of the level of a fluid in the shipping container for temperature inside the shipping container.
